(19) United States
(12) Patent Application Publication
(10) Pub. No.: US 2026/0045795 A1
(43) Pub. Date: Feb. 12, 2026

(54) Magnetic Field Coil Power Stabilizer for Stable Electrical Output in Electronic Devices

(71) Applicant: Huy Nguyen, Midway City, CA (US)

(72) Inventor: Huy Nguyen, Midway City, CA (US)

(21) Appl. No.: 19/083,588

(22) Filed: Mar. 19, 2025

Related U.S. Application Data
(60) Provisional application No. 63/681,467, filed on Aug. 9, 2024.

(51) Int. Cl. H02J 3/24; H01F 7/06; H01F 7/20; H01F 27/24; H01F 27/28

(52) U.S. Cl. CPC H02J 3/24; H01F 7/064; H01F 7/20; H01F 27/24; H01F 27/28

(57) ABSTRACT

The present invention relates to a field coil stable power system for generating and stabilizing electrical output. The system includes a ferromagnetic core, preferably made of iron, that interacts with a field coil. The field coil generates a magnetic field when current flows through it, and this magnetic field interacts with the magnetic field of a permanent magnet, producing attraction or repulsion forces on the ferromagnetic core. The ferromagnetic core absorbs magnetic energy and dissipates the magnetic energy gradually, preventing abrupt changes in current. The system is capable of stabilizing electrical output by balancing fluctuations in current and is applicable to various electronic devices, including audio equipment and medical devices.

### CROSS-REFERENCE TO RELATED APPLICATION

The present application claims priority to, and the benefit of, U.S. Provisional Application No. 63/681,467, which was filed on Aug. 9, 2024, and is incorporated herein by reference in its entirety.

### FIELD OF THE INVENTION

The present invention generally relates to power stabilization systems. More specifically, the invention relates to a field coil stable power system designed to generate and stabilize electricity for high-end audio equipment, medical devices, and other sensitive electronics. The system comprises a ferromagnetic core, preferably iron, around which a field coil is wound. The coil generates a magnetic field that interacts with a permanent magnet to dynamically adjust attraction or repulsion forces based on current intensity. The system absorbs excess magnetic energy for stabilizing current fluctuations and providing consistent power output. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, High-end audio equipment and sensitive electronic devices require clean and stable electric current to operate at their optimum level. Unstable or fluctuating current can lead to poor performance, noise, distortion, or even damage to the equipment. Transformers are commonly used to stabilize electric currents; however, transformers often do not provide the level of precision or clean power required by more expensive or specialized equipment. Transformers may reduce fluctuations to some degree, but they can introduce noise or instability, making them insufficient for certain high-performance applications.

Conventional systems also rely on electronic circuits to stabilize current, but these methods can be complex, inefficient, and prone to failure. Clean and stable power is also important for medical devices. In medical environments, equipment must operate reliably and accurately, where power fluctuations could compromise performance or even patient safety. People desire a system that provides a more precise power stabilization system.

Therefore, there exists a long-felt need in the art for a power stabilization system that provides a clean and stable current for high-end audio equipment, medical devices, and other sensitive electronic devices. There is a long-felt need for a power system that eliminates the fluctuations and instability typically experienced with conventional transformers. Additionally, there is a long-felt need for a power stabilization system that dynamically adjusts to current variations to provide consistent power output. Moreover, there is a long-felt need for a system that uses magnetic fields to absorb and dissipate excess energy to prevent abrupt changes in current. Further, there is a long-felt need for a system that stabilizes electrical current without requiring complex electronic circuits to provide a reliable and efficient solution. Finally, there is a long-felt need for a power stabilization system that can be easily integrated into various electronic devices, ensuring smooth operation and extending their operational lifespan.

The subject matter disclosed and claimed herein, in one embodiment, comprises a field coil stable power system for generating clean and stable electricity for use in sensitive electronics, including high-end audio equipment and medical devices. The system includes a ferromagnetic core, preferably made of iron, and interacts with a field coil to generate a magnetic field in response to electrical current. The system further includes a permanent magnet positioned adjacent to the iron core for dynamic magnetic interaction between the core and the magnet. The attraction or repulsion magnetic forces are adjusted based on the intensity of the current in the coil and stabilizes the output by absorbing and dissipating magnetic energy.

In this manner, the field coil stable power system of the present invention accomplishes all of the foregoing objectives, providing a dynamic, efficient, and reliable way to stabilize electrical current for high-end audio, medical equipment, and other sensitive electronics. The system offers a superior solution to traditional transformers by actively responding to current fluctuations and stabilizing output without introducing noise or interference. The system uses magnetic forces and an iron core to absorb excess energy to prevent spikes and dips in current that can compromise the operation of sensitive devices. The field coil stable power system eliminates the need for complex electronic circuits, providing a more straightforward and efficient solution for ensuring stable power across various applications.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a field coil stable power system for generating stable electrical output. The system includes a ferromagnetic core positioned to interact with a magnetic field, wherein the ferromagnetic core is capable of being temporarily magnetized, a field coil is wound around the ferromagnetic core, and the field coil is adapted to generate a magnetic field when an electric current flows through it, a power source is connected to the field coil to supply electric current, at least one permanent magnet is positioned near the ferromagnetic core, wherein the magnetic field generated by the field coil interacts with the magnetic field of the permanent magnet, and wherein the interaction of the magnetic fields creates attraction or repulsion forces on the ferromagnetic core, the magnitude of said forces is dependent on the current flowing through the field coil, wherein the ferromagnetic core absorbs magnetic energy and stabilizes the current in response to fluctuations in the current flowing through the field coil.

In another aspect, a power stabilization system is disclosed. The system includes a field coil configured to generate a magnetic field when an electrical current passes through it, a ferromagnetic core, the ferromagnetic core is responsive to the magnetic field generated by the field coil, and the ferromagnetic core absorbs the magnetic field to stabilize the current in response to fluctuations in the current flowing through the field coil.

In another embodiment, an apparatus for stabilizing current in electronic systems is disclosed. The apparatus includes a ferromagnetic core, a field coil wound around or positioned near the ferromagnetic core, configured to generate a magnetic field when current flows through it, a permanent magnet is positioned to interact with the magnetic field generated by the field coil and the magnetic properties of the ferromagnetic core; wherein variations in current flowing through the field coil modify the force of attraction or repulsion between the permanent magnet and the ferromagnetic core, stabilizing the current in the electronic system.

In another embodiment, a method for stabilizing electrical current in a field coil stable power system is disclosed. The method includes generating a magnetic field by passing an electrical current through a field coil that is wound around a ferromagnetic core, positioning at least one permanent magnet adjacent to the ferromagnetic core such that the magnetic field generated by the field coil interacts with the magnetic field of the permanent magnet, dynamically adjusting the attraction or repulsion forces between the ferromagnetic core and the permanent magnet in response to changes in the current flowing through the field coil, and absorbing magnetic energy with the ferromagnetic core by becoming temporarily magnetized and dissipating the energy gradually to prevent abrupt changes in electrical output.

In yet another aspect, the ferromagnetic core is made of iron, and the iron core is shaped to maximize magnetic interaction with the field coil and the permanent magnet to enhance current stabilization.

In one embodiment, the power source is a variable AC or DC power source, and the field coil is configured to adjust the strength of the magnetic field based on the variation in current supplied by the power source.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the field coil stable power system of the present invention in accordance with the disclosed structure;

FIG. 2 illustrates a perspective view showing another embodiment of the field coil stable power system of the present invention in accordance with the disclosed structure;

FIG. 3 illustrates a flow chart depicting a process of stabilizing output current using the field coil stable power system of FIG. 1 in accordance with the disclosed structure; and

FIG. 4 illustrates a perspective view showing the field coil stable power system of the present invention connected to a 3 AMP power supply in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a power stabilization system that provides a clean and stable current for high-end audio equipment, medical devices, and other sensitive electronic devices. There is a long-felt need for a power system that eliminates the fluctuations and instability typically experienced with conventional transformers. Additionally, there is a long-felt need for a power stabilization system that dynamically adjusts to current variations to provide consistent power output. Moreover, there is a long-felt need for a system that uses magnetic fields to absorb and dissipate excess energy for preventing abrupt changes in current. Further, there is a long-felt need for a system that stabilizes electrical current without requiring complex electronic circuits for providing a reliable and efficient solution. Finally, there is a long-felt need for a power stabilization system that can be easily integrated into various electronic devices, ensuring smooth operation and extending their operational lifespan.

The present invention, in one exemplary embodiment, is an apparatus for stabilizing current in electronic systems. The apparatus includes a ferromagnetic core, a field coil wound around or positioned near the ferromagnetic core, configured to generate a magnetic field when current flows through it, a permanent magnet is positioned to interact with the magnetic field generated by the field coil and the magnetic properties of the ferromagnetic core; wherein variations in current flowing through the field coil modify the force of attraction or repulsion between the permanent magnet and the ferromagnetic core, stabilizing the current in the electronic system.

Reference will now be made in detail to the present preferred embodiments of the invention, examples of which are illustrated in the accompanying drawings. Wherever possible, the same reference numerals are used in the drawings and the description to refer to the same or like parts.

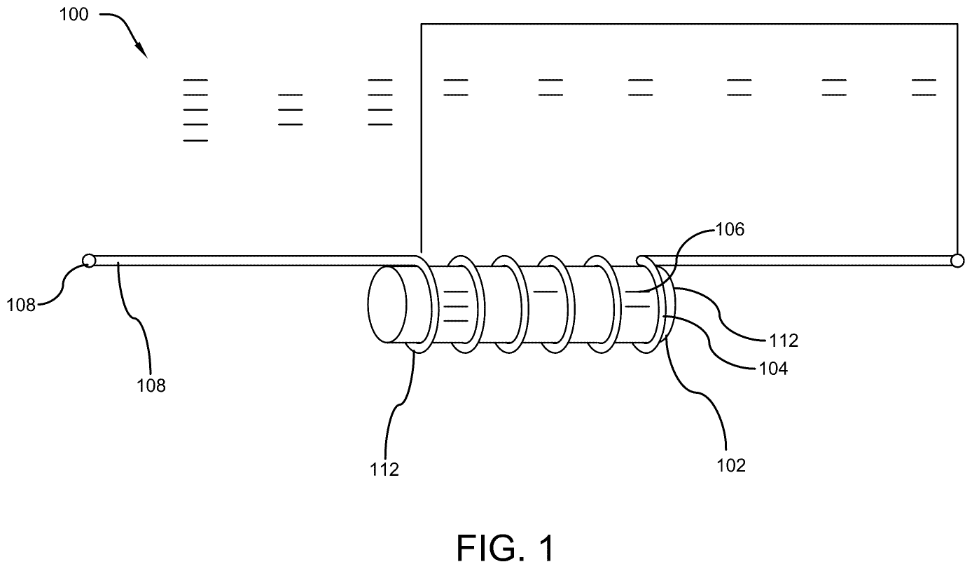

Referring initially to the drawings, FIG. 1 illustrates a perspective view of the field coil stable power system 100 in accordance with the disclosed structure. The field coil stable power system 100 is designed to generate stable electricity, making it suitable for various applications, including audio equipment, medical devices, and other electronic systems that require consistent power output. More specifically, the field coil-based power stabilization system 100 is comprised of at least one ferromagnetic core 102, preferably made of iron due to its soft magnetic properties. The iron core temporarily magnetizes when exposed to a changing magnetic field, allowing dynamic interaction with the field coil. The ferromagnetic core 102 may be shaped and sized according to the requirements of the specific circuit or power system it is implemented within, ranging from simple cylindrical shapes to complex geometries for specialized applications. This adaptability ensures that the system 100 can be integrated into diverse power stabilization needs.

A field coil 104 is wound around the ferromagnetic core 102, designed to produce a magnetic field 106 when energized. One end 108 of the field coil 104 is connected to a power source 110, which may be an AC or DC source depending on the intended application. The field coil 104 can be configured to match the power supply's characteristics, such as voltage, frequency, or waveform. When the power source 110 is activated, an electric current flows through the coil 104, generating a magnetic field 106 that interacts with the core 102. The number of turns in the coil 104, the thickness of the wire, and the material of the coil winding can be adjusted to control the intensity of the magnetic field generated, which influences the overall stability of the power output.

At least one permanent magnet 112 is positioned near, and preferably adjacent to, the iron core 102. The orientation and distance between the permanent magnet 112 and the core 102 are configured to optimize magnetic interactions. The magnetic field of the permanent magnet 112 is aligned such that it interacts with both the core 102 and the magnetic field generated by the field coil 104. When an electric current flows through the field coil 104, the generated magnetic field interacts with that of the permanent magnet 112, creating forces of attraction or repulsion depending on the relative polarities. The magnitude of these forces is proportional to the current flowing through the field coil 104. When the current increases, the generated magnetic forces intensify, and when the current decreases, the forces weaken, enabling dynamic adjustment of the system's response.

In one embodiment, when the current in the coil increases, the repulsion force between the iron core 102 and the permanent magnet 112 becomes stronger. This repulsive force opposes further current increase in the coil 104, thereby reducing the output and stabilizing the current. The temporary magnetization of the iron core 102 allows it to absorb magnetic energy and dissipate it gradually over time, thereby smoothing abrupt changes in the electrical output. Conversely, when the current decreases, the attraction force between the iron core 102 and the permanent magnet 112 increases, compensating for the lower current and maintaining a stable output. The self-regulating nature of this interaction allows the system to respond effectively to fluctuations in the input current, resulting in a consistent output suitable for sensitive electronic applications.

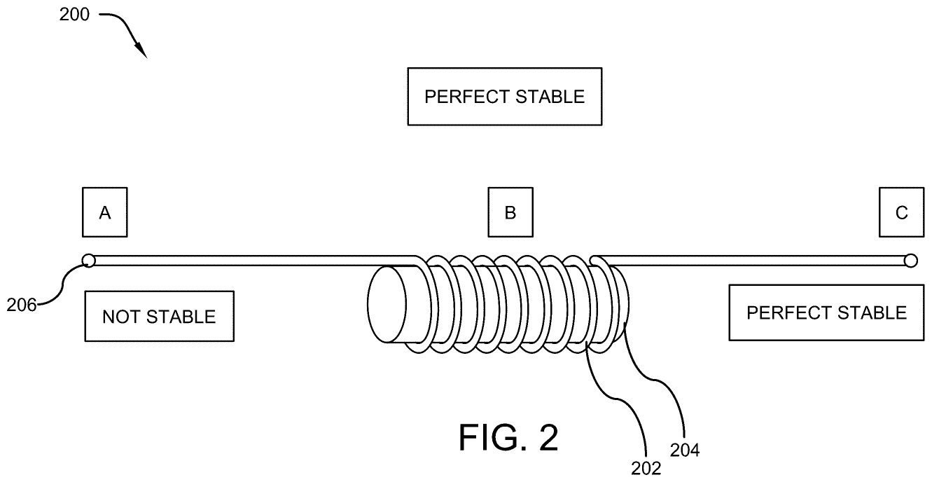

FIG. 2 illustrates a perspective view showing another embodiment of the field coil stable power system 100. In this configuration, a wire coil 202 is wound around an iron core 204. In this embodiment, a field coil-based power stabilization system 200 relies solely on electromagnetic induction, excluding the use of a permanent magnet. When electric current passes through the coil 202, it generates a magnetic field that induces a temporary magnetization in the iron core 204, transforming it into an electromagnet. The magnetization strength and polarity of the iron core 204 depend directly on the magnitude and direction of the current passing through the coil 202. This induced magnetism allows the core 204 to absorb magnetic energy and release it gradually, thereby damping fluctuations in the electrical output. The current supplied by the power source 206 is initially unstable, as indicated by region ‘A,’ but stabilizes in regions ‘B’ and ‘C’ due to the dynamic interaction between the coil 202 and the core 204, providing a smooth and reliable power output.

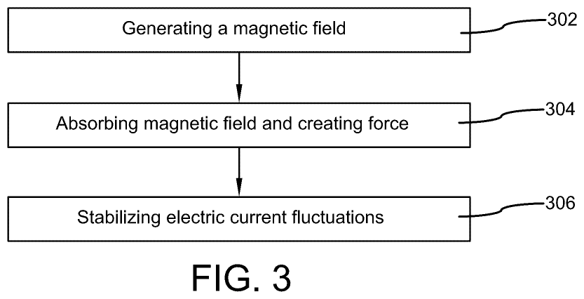

FIG. 3 illustrates a flow chart depicting a process for stabilizing output current using the field coil stable power system 100 as described in FIG. 1. Initially, the field coil 104 is connected to the power source, generating a magnetic field that corresponds to the strength of the input current (Step 302). The generated magnetic field is then absorbed by the iron core 102, which either attracts or repels the permanent magnet 112 depending on the polarity and intensity of the current (Step 304). This interaction between the magnetic fields of the core 102 and the permanent magnet 112 creates forces that balance fluctuations in the current (Step 306). The resulting effect is a steady, stable electrical output, even in the presence of variations in the input current. This process ensures consistent power delivery to connected devices, enhancing their reliability and performance.

The different embodiments of the field coil stable power system can be utilized in high-quality audio equipment to minimize disruptions such as noise or distortion in sound quality. By stabilizing the power supply, the system reduces fluctuations that could otherwise cause unwanted interference. Additionally, the system can ensure a stable power source for critical medical devices, which require consistent performance for accurate diagnostics and patient care. By providing a stable output even when faced with fluctuating input currents, the system improves the reliability of equipment in sensitive applications.

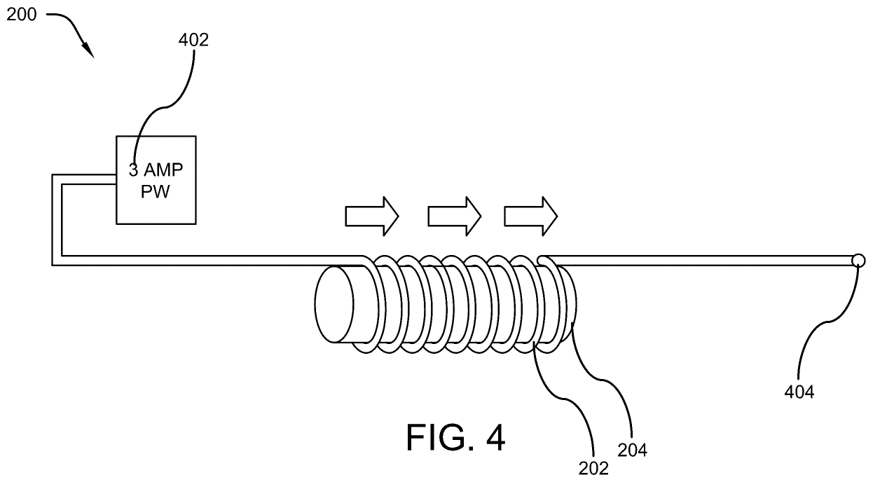

FIG. 4 illustrates a perspective view of the magnetic field coil power stabilizer system 100 connected to a 3 AMP power supply 402. The field coil 202 is connected to the power supply 402, where the current initially varies as it reaches the iron core 204. The system 200 stabilizes the current through the interaction between the coil 202 and core 204, delivering a consistent electric supply to the destination 404. The stabilization mechanism ensures that even as the input current varies, the output current remains steady, making the system suitable for applications that require a reliable 3 AMP supply. This adaptability to different power ratings extends the system's potential use in various electronic and industrial environments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “field coil-based power stabilization system”, “field coil stable power system”, “magnetic field coil power stabilizer system”, and “system” are interchangeable and refer to the field coil-based electric power stabilization system 100,200 of the present invention.

Notwithstanding the forgoing, the field coil-based electric power stabilization system 100,200 of the present invention can be of any suitable size and configuration as is known in the art without affecting the overall concept of the invention, provided that it accomplishes the above stated objectives. One of ordinary skill in the art will appreciate that the field coil-based electric power stabilization system 100,200 as shown in the FIGS. are for illustrative purposes only, and that many other sizes and shapes of the field coil-based electric power stabilization system 100,200 are well within the scope of the present disclosure. Although the dimensions of the field coil-based electric power stabilization system 100,200 are important design parameters for user convenience, the field coil-based electric power stabilization system 100,200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A field coil-based power stabilization system comprising:
a ferromagnetic core;
a field coil wound around the ferromagnetic core, the field coil being configured to generate a magnetic field when energized by a power source;
a permanent magnet positioned adjacent to the ferromagnetic core, wherein the magnetic field generated by the field coil interacts with the permanent magnet to produce a magnetic force; and
further wherein the magnetic forces adjust dynamically based on variations in current flowing through the field coil, thereby stabilizing a power output.

2. The field coil-based power stabilization system of claim 1, wherein the ferromagnetic core is comprised of an iron.

3. The field coil-based power stabilization system of claim 1, wherein the power source is comprised of an AC power source.

4. The field coil-based power stabilization system of claim 1, wherein the power source is comprised of a DC power source.

5. The field coil-based power stabilization system of claim 1, wherein the field coil rotates.

6. The field coil-based power stabilization system of claim 5, wherein the number of rotates of the field coil is based on the power source.

7. The field coil-based power stabilization system of claim 1, wherein the ferromagnetic core is comprised of a cylindrical shape.

8. The field coil-based power stabilization system of claim 1, wherein the ferromagnetic core is configured to temporarily magnetize when exposed to the magnetic field generated by the field coil.

9. The field coil-based power stabilization system of claim 1, wherein the field coil is configured to produce a magnetic field with an intensity that varies according to the current supplied by the power source.

10. A field coil-based power stabilization system comprising:
an iron core;
a field coil wound around the iron core configured to produce a magnetic field when connected to a power source;
wherein the iron core is temporarily magnetized by the magnetic field, enabling the iron core to absorb a magnetic energy and gradually dissipate the magnetic energy over time;
wherein the system stabilizes fluctuations in current supplied by the power source by adjusting the magnetic interaction between the field coil and the iron core.

11. The field coil-based power stabilization system of claim 10, wherein the field coil is wound with a wire.

12. The field coil-based power stabilization system of claim 10, wherein the wire matches a voltage of the power source.

13. The field coil-based power stabilization system of claim 11, wherein a thickness of the wire controls an intensity of the magnetic field.

14. The field coil-based power stabilization system of claim 10, wherein the field coil-based power stabilization system provides an initially unstable current that is stabilized by the dynamic interaction between the field coil and the iron core.

15. The field coil-based power stabilization system of claim 10, wherein the iron core dissipates the magnetic energy gradually to reduce noise or distortion in an output current.

16. The field coil-based power stabilization system of claim 10, wherein a magnetization strength of the iron core is directly proportional to a magnitude of the current supplied to the field coil.

17. A method of using a field coil-based power stabilization system, the method comprising the following steps:
generating a magnetic field through a field coil wound around a ferromagnetic core when the field coil is energized by a power source;
adjusting a magnetic interaction between the ferromagnetic core and an adjacent permanent magnet based on the current flowing through the field coil;
generating a magnetic force that opposes or assists changes in the current through the field coil; and
maintaining a stable output current from the field coil-based power stabilization system by compensating for a variation in an input current.

18. The method of using a field coil-based power stabilization system of claim 17 further comprising a step of detecting a change in the input current before adjusting the magnetic interaction.

19. The method of using a field coil-based power stabilization system of claim 17 further comprising a step of varying a polarity of the magnetic interaction between the ferromagnetic core and the permanent magnet.

20. The method of using a field coil-based power stabilization system of claim 17 further comprising a step of generating a smooth electrical output for medical devices requiring consistent power.
